(19) United States
(12) Patent Application Publication
(10) Pub. No.: US 2024/0342802 A1
(43) Pub. Date: Oct. 17, 2024

(54) BUILD PLATE WITH INTERCHANGEABLE INSERT TO REDUCE LIFT-UP DURING METAL 3D PRINTING

(71) Applicant: THE INDIUM CORPORATION OF AMERICA, Clinton, NY (US)

(72) Inventors: David P. Socha, Whitesboro, NY (US); Brent Muncy, Sauquoit, NY (US)

(21) Appl. No.: 18/633,203

(22) Filed: Apr. 11, 2024

Related U.S. Application Data
(60) Provisional application No. 63/458,768, filed on Apr. 12, 2023.

(51) Int. Cl. B22F 12/30; B33Y 30/00

(52) U.S. Cl. CPC B22F 12/30; B33Y 30/00

(57) ABSTRACT

Some implementations of the disclosure are directed to a build plate assembly including a body dimensioned for use in a 3D printing device, and a solid insert of a metal or metal alloy. The body includes an interior cavity formed through a top of the body, and extending to an opening at a first side of the body. The solid insert includes a top surface for forming a 3D printed metal object in the 3D printing device. The solid insert is configured to slidably couple, through the opening at the first side of the body, into the interior cavity of the body.

### CROSS-REFERENCE TO RELATED APPLICATIONS

This application claims priority to U.S. Provisional Patent Application No. 63/458,768, titled “BUILD PLATE WITH INTERCHANGEABLE INSERT TO REDUCE LIFT-UP DURING METAL 3D PRINTING” filed Apr. 12, 2023, which is incorporated herein by reference in its entirety.

### DESCRIPTION OF THE RELATED ART

Three-dimensional (3D) printing, also known as additive manufacturing, has gained in popularity as a technique to manufacture both prototypes and industrial parts. Increasingly, these parts have permeated into all sectors of industrial manufacturing including the aerospace, automotive, and dental sectors.

The process of additive manufacturing involves depositing print material into sequential layers onto a build plate until the desired 3D print is formed. 3D printing methods build parts layer by layer, but most require a platform or build plate to serve as the starting point. The first few layers of print material will bond onto the surface of the build plate, and the following layers build on this surface. When 3D printing 3D metal printed parts, the feedstock is made of metal powders or combination of powders. The build plate is placed into the 3D printing machine. Once the machine is activated, a blade deposits a layer of metal powder over the build plate. A laser or series of lasers selectively sinters the metal that will become part of the 3D printed object. The first few passes of the laser essentially weld what will become the 3D printing object to the build plate. The blade then deposits new powdered metal across the surface of the build plate. Selective sintering is repeated and the object is created layer by layer.

Despite the increasing use of additive manufacturing in high-tech industries, separation of the part from the build plate is still widely accomplished by cutting. Cutting devices used to separate the parts from the build plate include, hack saws, band saws, wire electrical discharge machines (EDM), and others. While the use of such devices is effective, it can be time consuming, and it can require large capital equipment purchases such as in the case of a wire EDM. Often, the removal and post-processing equipment can occupy a larger percentage of the shop floor than the machine(s) used for powder bed fusion to create the 3D printed part(s). In addition, mechanical separation of the 3D printed part from the build plate can require significant post-processing of both the removed part(s) and the build plate surface.

### BRIEF SUMMARY

Some implementations of the disclosure describe improvements to a thermally decomposable build plate for use with a 3D metal printer such as a laser powder bed fusion (PBF). The build plate is configured to help prevent lift-up of the metal printing surface, to improve tolerance of 3D printed parts, to improve the user experience, and/or to increase throughput. Some implementations of the build plate include a dovetailed rail system such that new metal insert print surfaces can be slid in or out of the build plate through a detachable gate. The dovetail features of the rail system can prevent lift up of the metal insert print surface while under thermal load during PBF laser printing of 3D metal objects. Further implementations of the disclosure describe a casting mold for forming a metal insert printing surface that is compatible with the improved build plate design.

In one embodiment, a build plate assembly comprises: a body dimensioned for use in a 3D printing device, the body comprising an interior cavity formed through a top of the body, and extending to an opening at a first side of the body; and a solid insert of a metal or metal alloy comprising a top surface for forming a 3D printed metal object in the 3D printing device, the solid insert configured to slidably couple, through the opening at the first side of the body, into the interior cavity of the body.

In some implementations, the build plate assembly further comprises a gate configured to removably couple to the first side of the body after the solid insert slidably couples into the interior cavity, the gate configured to block the opening at the first side of the body.

In some implementations, the gate slidably couples to the first side of the body.

In some implementations, the interior cavity comprises a first mortise or a first tenon; the solid insert comprises a second mortise configured to be slidably received by the first tenon, or a second tenon configured to be slidably received by the first mortise; and the gate comprises a third mortise configured to be slidably received by the first tenon, or a third tenon configured to be slidably received by the first mortise.

In some implementations, the gate comprises one or more first through holes extending through the gate; the body comprises one or more second through holes extending through the body; after the gate is removably coupled to the first side of the body, the one or more first through holes are aligned with the one or more second through holes; and the one or more first through holes aligned with the one or more second through holes are configured to receive one or more structural protrusions of the 3D printing device to hold the build plate assembly in place during 3D printing.

In some implementations, the interior cavity comprises a first mortise or a first tenon; and the solid insert comprises a second mortise configured to be slidably received by the first tenon, or a second tenon configured to be slidably received by the first mortise.

In some implementations, the first mortise or the first tenon are angled relative to a perpendicular direction to the top surface of the solid insert, and the second mortise or the second tenon are angled relative to the perpendicular direction to prevent movement of the solid insert along the perpendicular direction after the solid insert slidably couples to the interior cavity.

In some implementations, the interior cavity comprises the first mortise and the first tenon; and the solid insert comprises the second mortise configured to be slidably received by the first tenon, and the second tenon configured to be slidably received by the first mortise.

In some implementations, the interior cavity comprises a first plurality of mortises including the first mortise, and a first plurality of tenons including the first tenon; the solid insert comprises a second plurality of mortises including the second mortise, and a second plurality of tenons including the second tenon; the first plurality of mortises are configured to slidably receive the second plurality of tenons; and the first plurality of tenons are configured to slidably receive the second plurality of mortises.

In some implementations, the first plurality of mortises, the first plurality of tenons, the second plurality of mortises, and the second plurality of tenons is each angled relative to a perpendicular direction to the top surface of the solid insert to prevent movement of the solid insert along the perpendicular direction after the solid insert slidably couples to the interior cavity.

In some implementations, the interior cavity comprises a first bottom surface including the first mortise or the first tenon; and the solid insert comprises a second bottom surface, opposite the top surface, the second bottom surface comprising the second mortise or the second tenon.

In some implementations, the body comprises one or more through holes configured to receive a tool for slidably removing the solid insert from the interior cavity of the body, the one or more through holes extending through a second side of the body, opposite the first side, from an exterior of the second side to the interior cavity.

In some implementations, the metal or metal alloy has a solidus temperature that is lower than a solidus temperature of the 3D printed metal object.

In some implementations, the solidus temperature of the metal or metal alloy is between 50° C. and 250° C.

In some implementations, the interior cavity comprises one or more subtractive features; the solid insert comprises one or more additive features coupled to the one or more subtractive features when the solid insert is slidably coupled in the interior cavity; and the one or more additive features coupled to the one or more subtractive features is configured to prevent lift-up of the solid insert during 3D printing in the 3D printing device.

In some implementations, the interior cavity comprises one or more additive features; the solid insert comprises one or more subtractive features coupled to the one or more additive features when the solid insert is slidably coupled in the interior cavity; and the one or more subtractive features coupled to the one or more additive features is configured to prevent lift-up of the solid insert during 3D printing in the 3D printing device.

In one embodiment, a method comprises: positioning a build plate assembly in a 3D printing device, the build plate assembly comprising a body with an interior cavity, and a solid insert of a metal or metal alloy slidably coupled in the interior cavity; forming, using the 3D printing device, a 3D printed metal object onto a surface of the solid insert, the metal or metal alloy having a solidus temperature that is lower than a solidus temperature of the 3D printed metal object; after forming the 3D printed metal object onto the surface of the solid insert, slidably removing the solid insert from the interior cavity through an opening at a first side of the body; and after slidably removing the solid insert from the interior cavity, melting the solid insert to release the 3D printed metal object.

In some implementations, the build plate assembly further comprises: a gate removably coupled to the first side of the body and blocking the opening at the first side of the body; and the method further comprises: before slidably removing the solid insert from the interior cavity, removing the gate from the first side of the body.

In some implementations, the method further comprises: before positioning the build plate assembly in the 3D printing device: slidably inserting the solid insert in the interior cavity through the opening at the first side of the body; and after slidably inserting the solid insert in the interior cavity, removably coupling the gate to the first side of the body.

In some implementations, the body comprises one or more through holes extending through a second side of the body, opposite the first side, from an exterior of the second side to the interior cavity; and slidably removing the solid insert from the interior cavity comprises: applying, using a tool inserted in the one or more through holes, force to the solid insert to slide the solid insert through the opening at the first side of the opening.

In one embodiment, a mold for casting a solid metal insert for a build plate, comprises: a first side comprising a first interior casting cavity; and a second side comprising a second interior casting cavity, the second interior casting cavity configured to face the first interior casting cavity when the mold is in a closed position, wherein the mold is configured such that: when the mold is in the closed position, a pour hole of the mold is configured to receive a molten metal that solidifies in the first interior casting cavity and the second interior casting cavity to form the solid metal insert, and after the solid metal insert is formed and the mold is in an open position, the solid metal insert is slidably removable from the second interior casting cavity.

In some implementations, the second interior casting cavity includes a first additive feature or a first subtractive feature; and the solid metal insert that is formed includes a second subtractive feature corresponding to the first additive feature or a second additive feature corresponding to the first subtractive feature.

In some implementations, the second interior casting cavity includes a first mortise or a first tenon; and the solid metal insert that is formed includes a second tenon corresponding to the first mortise or a second mortise corresponding to the first tenon.

In some implementations, the mold further comprises a mold gate configured to removably couple to the second side, the mold gate configured to block an opening at the second side from which the solid metal insert is slidably removable from the second interior casting cavity.

In some implementations, the first side comprises a first portion of the pour hole; and the second side comprises a second portion of the pour hole that faces the first portion of the pour hole when the mold is in the closed position.

In some implementations, the first side and the second side are configured to removably couple in the closed position; and the first side and the second side are configured to be separated in the open position.

Other features and aspects of the disclosed technology will become apparent from the following detailed description, taken in conjunction with the accompanying drawings, which illustrate, by way of example, the features in accordance with implementations of the disclosed technology. The summary is not intended to limit the scope of any inventions described herein, which are defined by the claims and equivalents.

It should be appreciated that all combinations of the foregoing concepts (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

The present disclosure, in accordance with one or more implementations, is described in detail with reference to the following figures. The figures are provided for purposes of illustration only and merely depict example implementations. Furthermore, it should be noted that for clarity and ease of illustration, the elements in the figures have not necessarily been drawn to scale.

Some of the figures included herein illustrate various implementations of the disclosed technology from different viewing angles. Although the accompanying descriptive text may refer to such views as “top,” “bottom” or “side” views, such references are merely descriptive and do not imply or require that the disclosed technology be implemented or used in a particular spatial orientation unless explicitly stated otherwise.

FIG. 1 shows a perspective view of an insert casting mold assembly in an open position, in accordance with some implementations of the disclosure.

FIG. 2 shows a perspective view of the mold of FIG. 1 in a closed position, and molten metal poured through a pour hole into the casting cavity to form a metal insert.

FIG. 3 shows a top view of the mold of FIG. 2.

FIG. 4 shows a perspective view of the mold of FIG. 1 after forming a metal insert and reopening the mold.

FIG. 5 shows a perspective view of the metal insert being slidably removed from the mold shown FIG. 4.

FIG. 6 shows a perspective view of a build plate body and build plate gate of a 3D metal printing build plate assembly, in accordance with some implementations the disclosure.

FIG. 7 shows a perspective view of a build plate body, a build plate gate, and a solid metal insert of a 3D metal printing build plate assembly, in accordance with some implementations the disclosure.

FIG. 8 shows a perspective view of the 3D metal printing build plate assembly of FIG. 7 after slidably inserting the solid metal insert into a cavity of the build plate body.

FIG. 9 shows a perspective view of the 3D metal printing build plate assembly of FIG. 8 after coupling the build plate gate to the build plate body.

FIG. 10 illustrates a 3D metal printing process including a 3D metal printing device using a metal powder bed and a laser to form a 3D printed metal object on the solid metal insert of the build plate assembly of FIG. 9, in accordance with some implementations of the disclosure.

FIG. 11 shows a 3D metal build plate assembly being disassembled after printing a 3D metal object on a surface of a solid metal insert of the assembly, in accordance with some implementations of the disclosure.

FIG. 12 depicts a 3D printed metal object being separated from a solid metal insert, in accordance with some implementations of the disclosure.

The figures are not exhaustive and do not limit the present disclosure to the precise form disclosed.

### DETAILED DESCRIPTION

There is a need for improving techniques in additive manufacturing for removing workpieces that are attached to a build plate. As described above, some current approaches rely on mechanical means of removal that may be time-consuming, require significant post processing time, and may require additional consumable metal powder to have sufficient standoff between the part and the build plate to allow access for the band saw or wire EDM clearance. One recently proposed technique that has proven effective for removal of 3D printed parts, and overcomes the challenges listed above, involves a thermally decomposable build plate design that utilizes a lower melting point metal as the build surface that allows parts printed by powder bed fusion to be released in seconds with a mild thermal treatment. In contrast to mechanical removal of a 3D printed metal part that often necessitates hours of post processing to reshape and polish the bottom of the object and to resurface the build plate for reuse, a thermally decomposable build plate enables facile removal of a 3D printed object from the build plate without damage to the 3D printed part, and little or no post processing, finishing, reshaping, and/or polishing of the 3D printed object.

Implementations of the disclosure describe improvements to a thermally decomposable build plate for use with a 3D metal printer such as a laser PBF. The improved thermally decomposable build plate design is configured to help prevent lift-up of the metal printing surface, to improve tolerance of 3D printed parts, to improve the user experience, and/or to increase throughput. Some implementations of the build plate include a dovetailed rail system such that new metal insert print surfaces can be slid in or out of the build plate. The dovetail features of the rail system can prevent lift up of the metal insert print surface while under thermal load during PBF laser printing of 3D metal objects. Further implementations of the disclosure describe a casting mold for forming a metal insert printing surface that is compatible with the improved build plate design. These and other implementations are further described below.

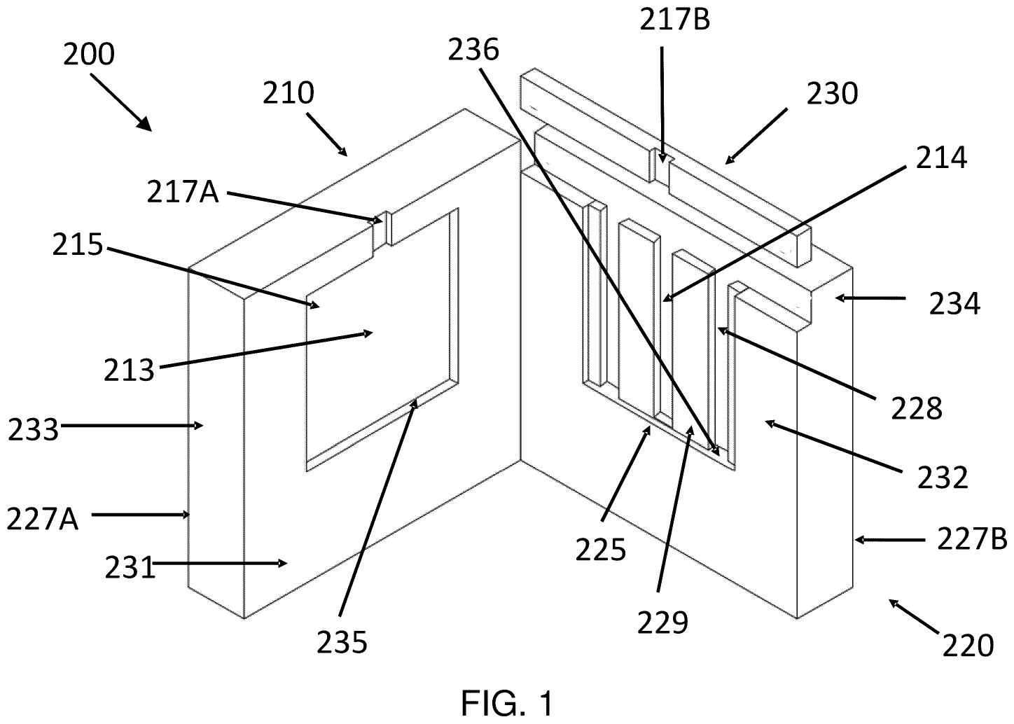

FIG. 1 shows a perspective view of a two-part insert casting mold assembly 200 (referred to herein as “mold 200”) in an open position. The mold 200 can be used for casting a metal insert 250 that is thermally decomposable and provides a print surface for 3D printed metal objects, such as those created by laser PBF.

The mold 200 includes two portions/sides-portion/side 210 and portion/side 220. Side 210 includes a framed interior surface 231, exterior sidewalls 233 (e.g., four), and an exterior surface 227A. The framed interior surface 231 includes an interior casting cavity 215 and pour hole portion 217A. In this example, the pour hole portion 217A also partially extends into an exterior sidewall 233. The interior casting cavity 215 of side 210 contains an interior bottom surface 213 and interior side walls 235 (e.g., four interior side walls). The depth of the interior casting cavity 215 is less than the thickness of the metal insert 250 produced by the mold 200.

Side 220 of the mold 200 includes an interior surface 232, exterior sidewalls 234 (e.g., four), exterior surface 227B, and a detachable mold gate 230 with a pour hole portion 217B therein. An interior casting cavity 225 is formed through the interior surface. When the detachable mold gate 230 is coupled to side 220 (FIG. 1 illustrates the gate decoupled), a framed surface is created around the interior casting cavity 225, with surface 232 encompassing three sides of the frame, and the gate 230 having the fourth side of the frame.

The interior casting cavity 225 contains an interior bottom surface 214 and multiple interior side walls 236. The depth of the interior insert casting cavity 225, measured from the top surface of the frame to the lowest point(s) of the bottom surface 214 of cavity 225, may be less than the thickness of the metal insert 250 produced by the mold 200.

In this example implementation, the interior bottom surface 214 of cavity 225 contains alternating mortises 228 and tenons 229 that serve to impart the negative feature onto the metal insert 250 being casted. For example, the casting mold tenons 229 form a mortise 238 on the casted metal insert 250 whereas the casting mold mortises 228 form a tenon 239 on the casted metal insert 250. The mortises 228 and tenons 229 on the interior bottom surface 214 of side 220 of the mold 200 run parallel to each other and run perpendicular to the detachable mold gate 230 in its seated position within side 220 of the mold.

The tenons 229 on side 220 of the insert casting mold can contain dovetailed features such that the portion of each individual tenon 229 in touching relation with the bottom surface of the interior insert casting cavity 225 of side 220 has a smaller surface area than the side of the tenon 229 opposite the side touching the bottom surface of the interior cavity 225. In other words, each tenon 229 on the side 220 of the mold can slope inward towards the bottom of the recessed cavity 225. These dovetail features can slope from 5 degrees to 45 degrees to perpendicular. The dovetail features can be created when machining the mortise channels into the interior insert casting cavity 225 of side 220. Similarly, the corresponding tenons 239 and mortises 238 of the casted metal insert 250 can slope at a similar angle (e.g., 5 degrees to 45 degrees) to perpendicular such that tenons 239 widen and mortises 238 narrow away from the build surface of metal insert 250.

In alternative implementations, the interior bottom surface 214 of cavity 225 or some other surface of cavity 225 can contain other physical features that impart negative and/or positive features onto the metal insert 250 being cast. For example, the cavity 225 can contain straight box channels. In addition, in some implementations both cavity 225 and cavity 215 can contain physical features that impart negative and/or positive features onto the metal insert 250 being cast.

The detachable mold gate 230 on side 220 contains a rectangular trench opening or pour hole portion 217B that extends from the bottom to the top of the detachable mold gate 230. The pour hole portion 217B within the detachable mold gate 230 faces the interior of the mold 200 while in its seated position. The depth of the pour hole portion 217B can be approximately one half the thickness of the gate 230. This pour hole portion 217B can serve as about one half of the pour hole.

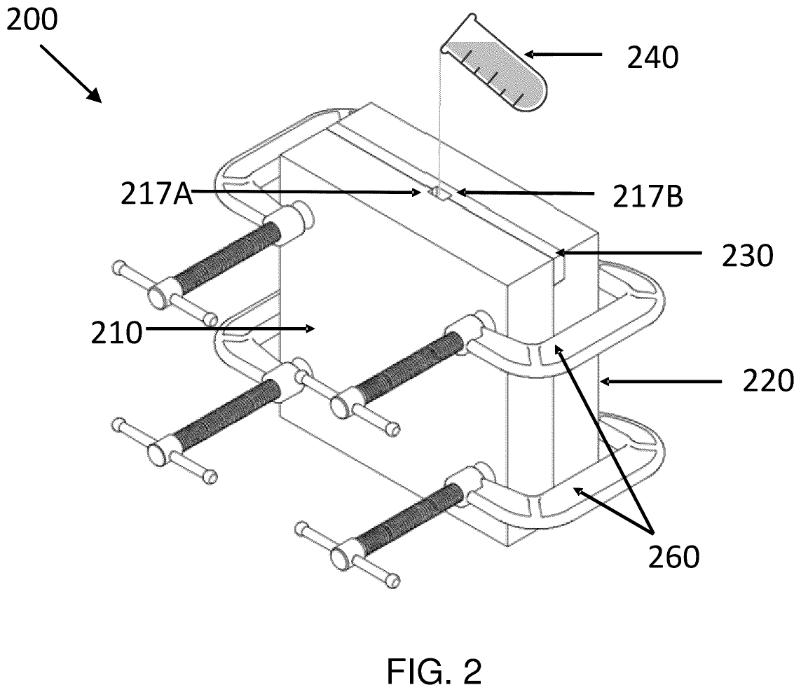

FIG. 2 shows a perspective view of mold 200 in a closed position. Prior to pouring the molten metal 240 into the mold 200, it should be placed in the closed position such that the surface 231 of side 210 is in touching relation with the surface 232 of side 220, and the interior casting cavity 215 faces interior casting cavity 225. In addition, pour hole portions 217A and 217B come together to form a pour hole. In this example, the pour hole is formed at the top of the closed mold. In some implementations, one or more additional holes may be present on the mold 200, to allow air to escape during filling. The one or more additional holes can be placed adjacent to the primary pour hole portions 217A and 217B.

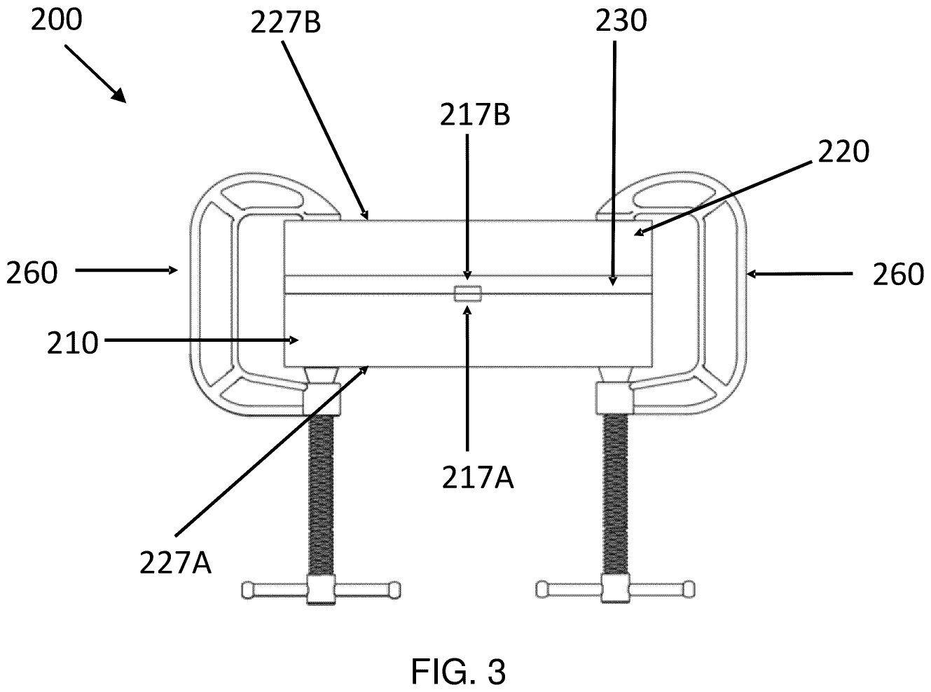

Once together in the closed position with the two interior cavities facing, the two sides 210 and 220 of the mold 200 can be removably secured together with clamps 260 or some other securing mechanism to ensure no molten metal 240 leaks from the mold 200 during or after the filling process, prior to solidification of the molten metal 240. In addition, securing together sides 210 and side 220 of the mold 200 can ensure that both sides of the mold are properly aligned and that the mold 200 will produce a cast metal insert 250 within specifications to slide into a build plate receiving cavity (e.g., interior cavity 115), further described below. FIG. 3 shows a top view of the mold 200 fixed in the closed position utilizing clamps 260 as previously shown in FIG. 2. In some implementations, more than one clamping device may be utilized on each side of mold 200. In another implementation, bolt holes instead of clamps can be used to secure both sides of the mold together in the closed position. In other implementations, a hinged mechanism can be used to rotatably couple the two sides 210 and 220 such that the two sides rotate between a closed position and an open position. In such implementations, a combination of hinges and clamps can be used to fix sides 210 and 220 of mold 200 in the closed position prior to adding the molten metal 240.

In some implementations, once the gate 230 is seated within side 220 of the mold, the gate 230 can be held in place by pressure once the surfaces 231 and 232 are in touching relation, and the clamps 260 or other securing mechanism have secured the mold in the closed position

During casting, molten metal 240 is poured through the pour hole into the casting cavities 215 and 225 to form a metal insert 250. Prior to filling the mold 200 with molten metal 240, it may be advantageous to heat the mold 200 above the solidus point of the poured molten metal 240. Preheating the mold 200 prevents premature solidification of the molten metal 240 prior to fully filling the mold 200. This preheating step can decrease the chance of voids forming in the casted metal insert 250 once solidification occurs.

Once the molten metal 240 cools below its solidus point, the mold 200 can be disassembled so that the solidified metal insert 250 can be removed from side 220. To disassemble the mold 200, the clamps 260 (or other securing mechanism) can be removed from the mold 200, allowing the two sides 210, 220 of the mold 200 to separate and opening the mold 200. The detachable mold gate 230 can then be separated from the side 220.

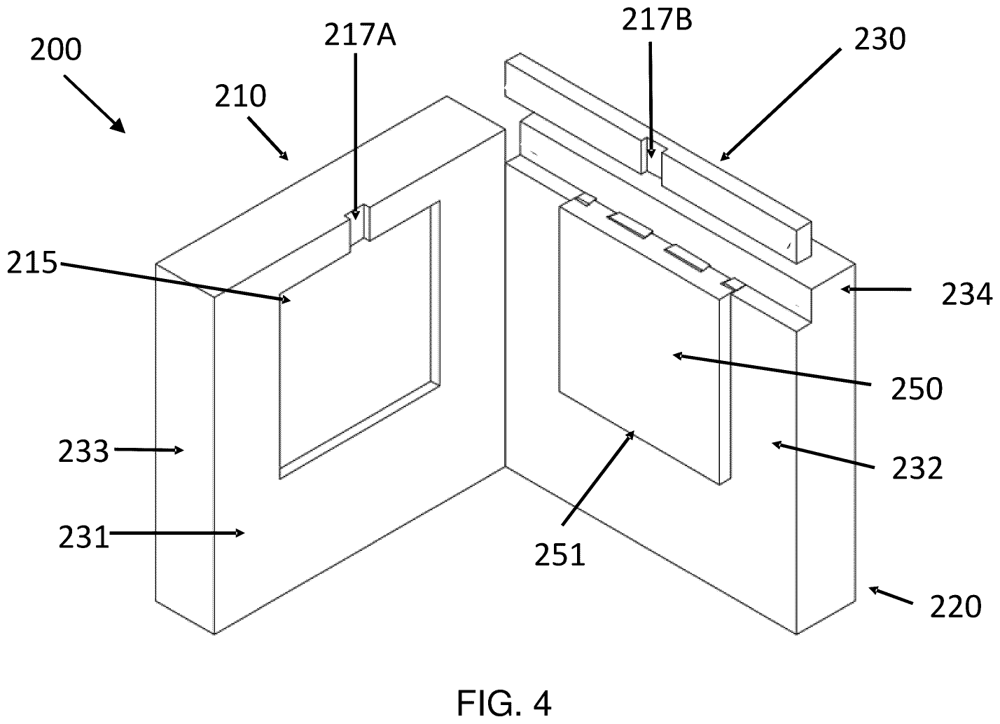

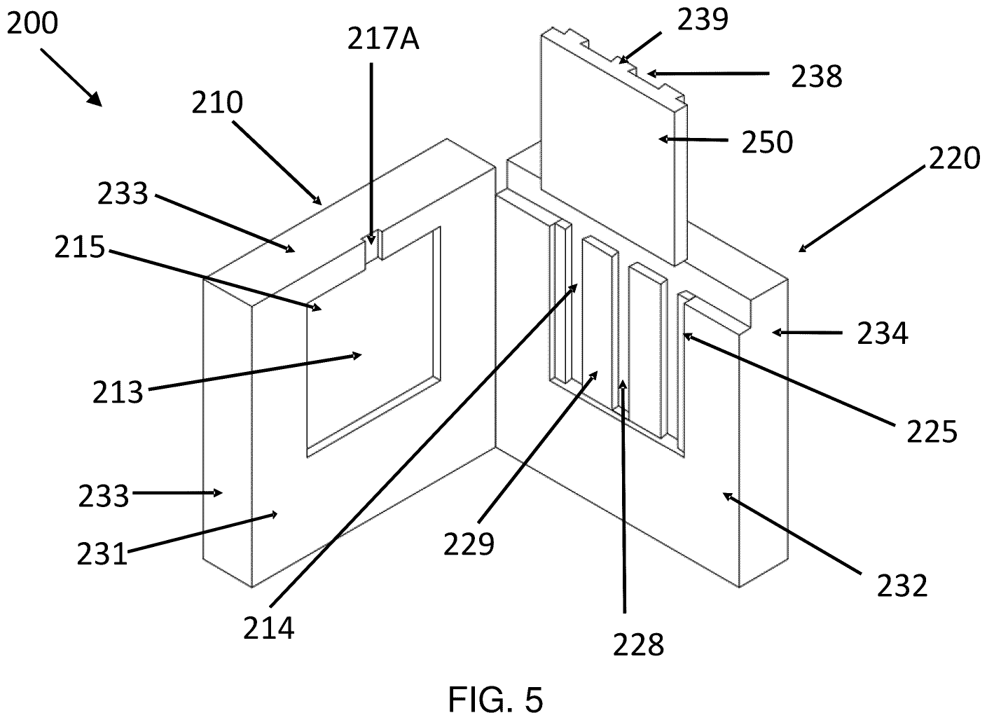

FIG. 4 shows a perspective view of the mold 200 after forming the metal insert 250 and reopening the mold. FIG. 5 shows a perspective view of the metal insert 250 being removed from the mold 200. As depicted, once the securing features (e.g., clamps 260) are removed from the mold 200, side 210 and side 220 can be separated from each other so that the interior surfaces 231 and 232, respectively, are no longer in touching relation with its opposing counterpart. Detachable gate 230 can then be separated from side 220.

As shown in FIG. 4, in this example a lip 251 is present where the casted metal insert 250 extends above the surface 232 surrounding cavity 225. Pressure may be exerted on the lip 251 opposite the side of the detachable mold gate 230 and pulled along mortises 228 and tenons 229 until the metal insert 250 exits side 220 of the insert casting mold. As shown in FIG. 5, once detachable gate 230 has been separated from side 220, the casted metal insert 250 can then be removed from cavity 225, which is located on side 220.

In the illustrated example of FIGS. 1-5, casting mold side 220 has been designed such that the fully solidified casted metal insert 250 can be slid along the dovetailed mortises 228 and tenons 229 and removed from the opening created once detachable gate 230 is removed. In cases where the molten metal 240 is poured to the top of the pour hole formed by pour holes portion 217A and 217B, an undesirable “nub” (not pictured) in the shape of the pour hole can be imparted into the casted metal insert 250. The positive nub feature can be created when the molten metal 240 solidifies within the pour hole. In such cases, after removal of the solidified metal insert 250 from insert cavity 225, the nub can be easily removed with a saw, clippers or by other mechanical means. In some cases, if the molten metal 240 is filled to the top of the pour hole, and a contraction of the molten metal 240 occurs during solidification, the contraction can be sufficient to eliminate or reduce the size of the nub created in the pour hole cavity.

In some implementations, the solid metal insert 250 is a solid metal or metal alloy having a solidus temperature of less than 300° C. In some implementations, it has a solidus temperature between 50° C. and 250° C. For example, the solid metal insert 250 can be a solder alloy such as tin alloys (e.g., 96.5Sn3Ag0.5Cu), bismuth alloys (e.g., 58Bi42Sn) or indium alloys (e.g., 52In48Sn). In some implementations, the solid metal insert can include at least 90% indium. In some implementations, the solid metal insert can be an InAg alloy. In other implementations, the solid metal insert can be a single elemental metal such as tin, indium, bismuth, or others.

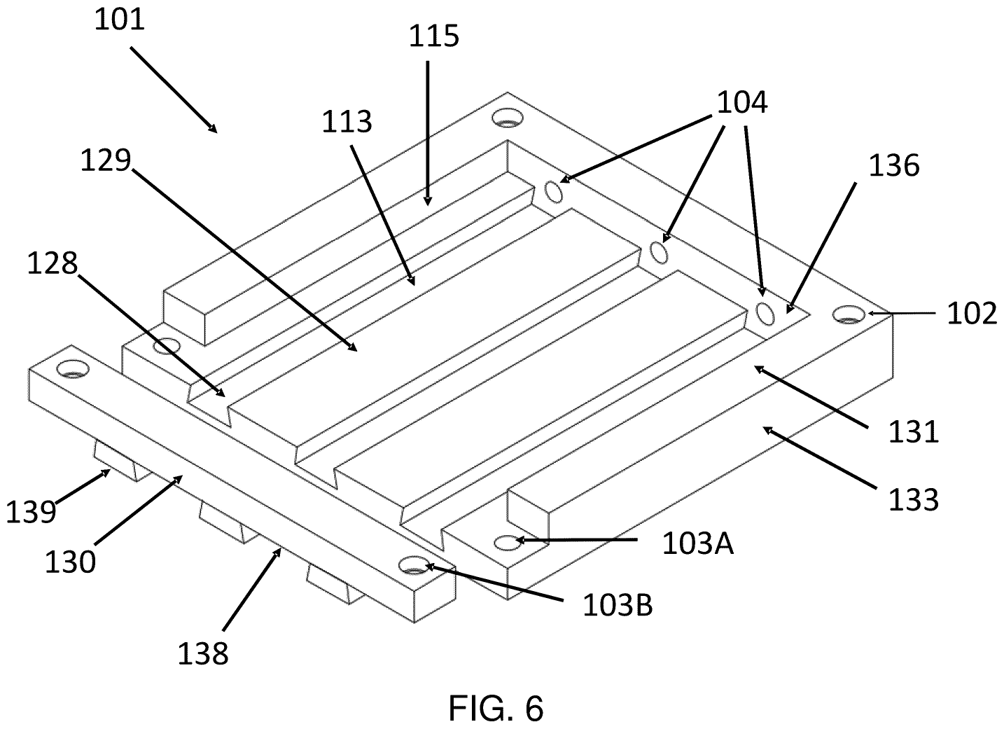

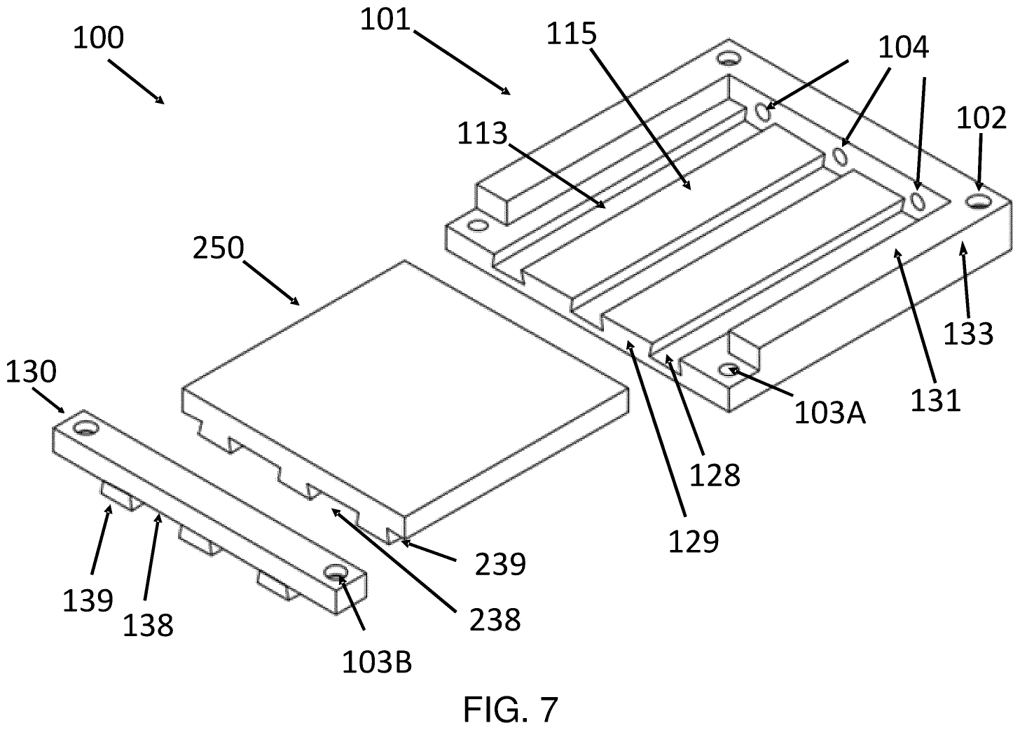

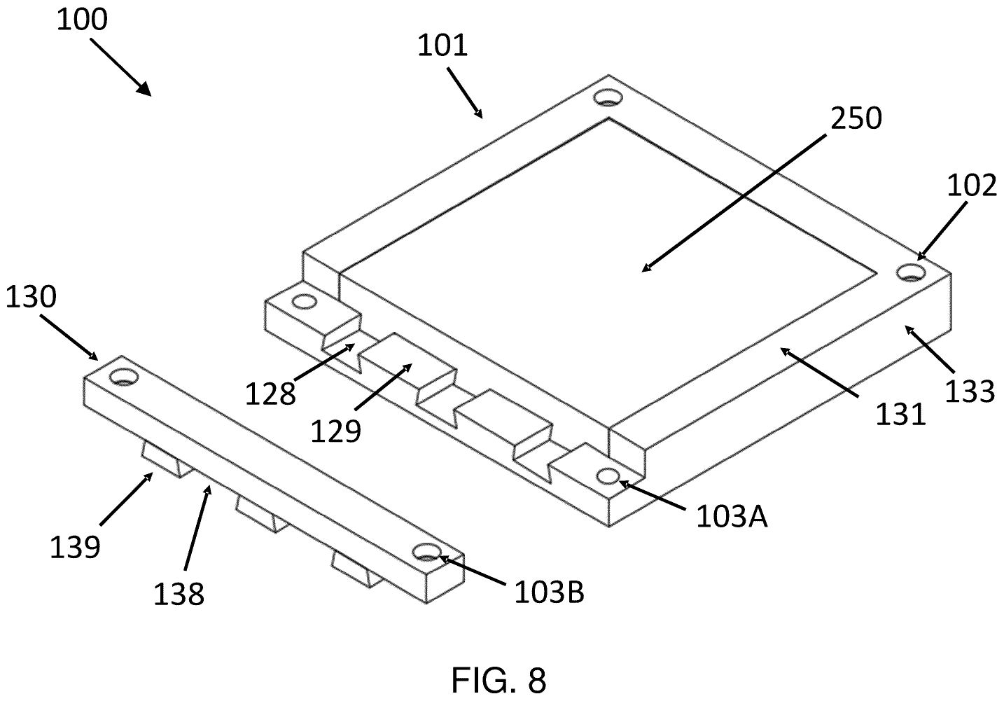

FIGS. 6-8 show a perspective views of a 3D metal printing build plate assembly 100, in accordance with some implementations the disclosure. The build plate assembly 100 includes a build plate body 101, a build plate gate 130 that detachably couples to build plate body 101, and a metal insert 250. As shown by FIGS. 7-8, The build plate body 101 is configured to removably accept a metal insert 250 formed in a casting mold. For example, the build plate body 101 can be configured to accept a metal insert formed using the mold 200 described above with reference to FIGS. 1-5.

The build plate body 101 includes a framed top surface 131 with an interior cavity 115. The interior cavity 115 includes a bottom surface 113 and multiple interior sidewalls 136. When the build plate gate 130 is removably coupled to the build plate body 101, the framed portion of a fourth interior sidewall is created. The interior cavity 115 of the build plate body 101 contains a series of mortises 128 and tenons 129 on the bottom surface 113. In this example, the mortise and tenon features run parallel to each other and perpendicular to the fourth framed wall of the build plate assembly 100 formed by placing build plate gate 130 in its seated position within the build plate body 101. The mortises 128 and tenons 129 can correspond to the tenons 239 and mortises 238 of the casted metal insert 250 and slope at a similar angle (e.g., 5 degrees to 45 degrees) to perpendicular such that tenons 129 narrow and mortises 128 widen toward the bottom surface of interior cavity 115. As further described below, by virtue of this dovetailed configuration that “locks” the metal insert 250 in place, vertical movement of metal insert 250 can be prevented during 3D printing.

In this example, the build plate gate 130 that detachably couples to the build plate body 101 contains mortises 138 and tenons 139. Like the casted metal insert 250, the tenons 139 on the build plate gate 130 can slope down and outward towards interior sidewalls 136 of the build plate, perpendicular to the direction of the rail system.

The build plate gate 130 in this example also contains two through holes 103B present on opposite ends of the top side of the gate 130, and extending through the bottom surface of the gate 130. The build plate body 101 contains two holes 103A on two adjacent corners. When the detachable build plate gate 130 is detachably seated in its fixed position within the build plate body 101, the through holes 103B on the gate 130 can align with the holes 103A on the build plate body 101 such that from the top view looking down at the gate 130/build plate body 101, it can appear to be one continuous hole from the top of the gate 130 through to the bottom of the build plate body 101. A light shined on the top of the build plate gate 130 through the holes 103B can appear from the respective holes 103A through the bottom of the build plate body 101. When detachably mounting the build plate assembly 100 into a 3D printing machine, bolts 105 or other fasteners can pass through holes 103B/103A to secure the gate 130 to the build plate body 101, and to secure the build plate assembly 100 to the 3D printing machine. In addition to holes 103A, holes 102 can be located in the remaining two top corners of build plate body 101 and extend through to the bottom of the build plate body 101. Bolts 105 or other fasteners can pass through holes 102 to further secure the build plate assembly 100 to the 3D printing machine. The 3D printing machine system can include structural protrusions (e.g., bolts or tabs) that can be inserted into the fastening holes described above to hold the build plate assembly 100 in place during 3D printing.

It should be appreciated that embodiments described herein need not be limited to the precise fastening hole locations, or the number of fastening holes shown in the diagrams. It is contemplated that fewer or additional holes can be used for securing the build plate assembly 100 to the 3D printing machine. In addition, in some implementations a protrusion (e.g., bolt or tab) can be used in place of a hole (e.g., hole 102). For example, the protrusion may couple to a hole of the 3D printing apparatus.

As depicted by FIGS. 7-8, the build plate body 101 of build plate assembly 100 can slidably receive the metal insert 250 via a dovetailed rail system of the build plate body 101. To realize this rail system, the mortises 128/129 and tenons 129/229 of the build plate body 101 and side 220 of the casting mold can have the same or substantially the same configuration. In addition, the mortises 138 and tenons 139 of build plate gate 130 and the mortises 238 and tenons 239 of solid metal insert 250 can have the same or substantially the same configuration, but complimentary to the mortises 128/228 and tenons 129/229 on the build plate body 101 and the side 220 of the casting mold. In other words, where there is a tenon 129 on the build plate body 101 and a tenon 229 on the side 220, there can be a mortise 138 in a similar position on gate 130 and a mortise 238 in a similar position on the solid metal insert 250. Where there is a mortise 128 on the build plate body 101 and a mortise 228 on the side 220, there can be a tenon 139 in a similar position on gate 130 and a tenon 239 in a similar position on the solid metal insert 250.

To guide the metal insert 250 into build plate body 101, the metal insert 250 can be placed in alignment with the build plate body 101 and slid along the mortise 128 and tenon 129 rail system of the build plate body 101 such that a mortises 128 on the build plate body 101 line up with tenons 239 on the metal insert 250 and tenons 129 on build plate body 101 line up with mortises 238 on metal insert 250. The proper alignment of the mortise and tenon features of the build plate assembly components described above can ensure that the solid metal insert 250 slides out of the casting mold 200 and into the build plate body 101 onto which gate 130 is coupled.

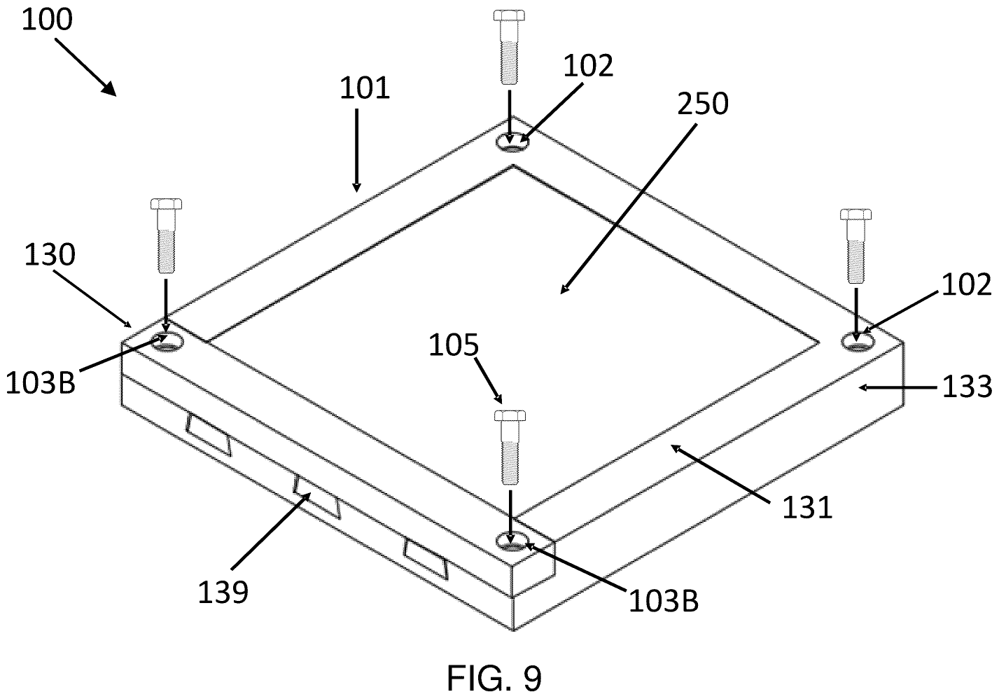

As shown in FIG. 8, once the metal insert 250 is seated in place in the build plate body 101, the detachable build plate gate 130 can be slid along the remaining exposed build plate rails until build plate gate 130 is seated in place in the build plate body 101. As shown in FIG. 9, bolts 105 or other fasteners can then be placed through the holes 103A and 103B to secure the gate 130 to the build plate body 101, completing the build plate assembly 100. The holes 103A/103B used to secure detachable build plate gate 130 to the build plate can also extend to secure the build plate assembly 100 into the 3D metal printing machine. Holes 102 can be used to secure the build plate assembly 100 into the 3D printing machine. FIG. 9 shows the fully assembled build plate assembly 100 prepared to be placed into a 3D printing machine and secured in place with bolts 105.

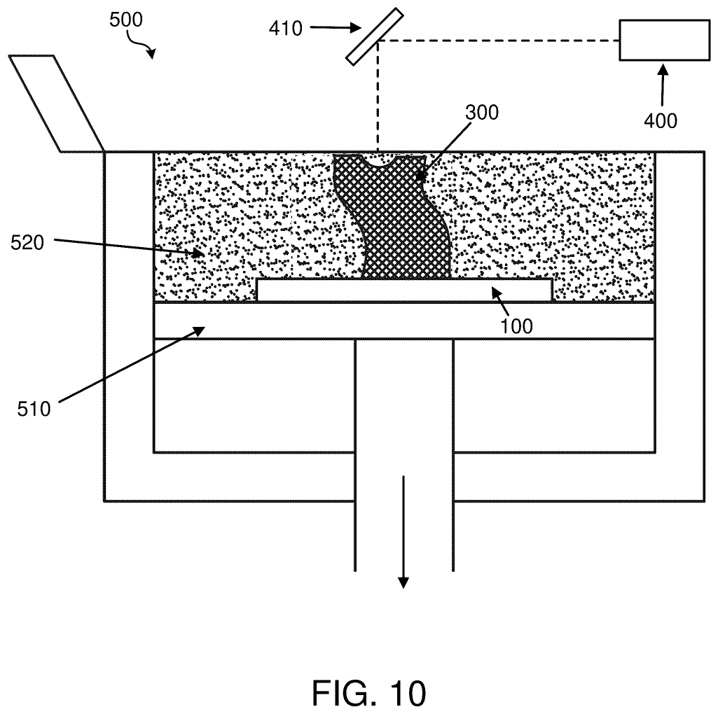

FIG. 10 illustrates a 3D metal printing process including a 3D metal printing device 500 using a metal powder bed 520 and a laser 400 to form a 3D printed metal object 300 on the metal insert 250 of build plate assembly 100, in accordance with some implementations of the disclosure. Also shown is build plate loading platform 510 and optical component 410 for directing the output of a laser 400. The metal powder bed 520 can comprise aluminum, cobalt, copper, nickel, steel, stainless steel, titanium, vanadium, tungsten carbide, gold, bronze, platinum, silver alloys, cobalt-chromium alloys, refractory metals, a combination thereof, or some other suitable metal or metal alloy for forming 3D printed metal object 300.

To prepare device 500 for printing, a build plate assembly 100, including solid metal insert 250, can be placed into the device 500 and secured to the build plate loading platform 510 by fasteners with the build surface facing upwards. The device 500 can be loaded with metal powder and a chamber door closed. The chamber can then be filled with an inert gas such as nitrogen or argon to prevent oxidation during the printing process. In some implementations, the 3D printing chamber and/or the build plate can be pre-heated at a temperature below the solidus temperature of solid metal insert 250

At the start of printing, a re-coater blade or other component of device 500 can deposit metal powder over the top surface of solid metal insert 250. A laser 400 or a series of lasers can then lase/sinter the deposited metal powder and metallurgically join/weld, a layer of what will become the 3D printed metal object 300, to the build surface of solid metal insert 250 The process can repeat layer by layer until the print is complete. The device 500 can include a lowering mechanism (e.g., as part of build plate loading platform 510) apparatus to allow for subsequent metal layers of the 3D printed metal object 300 to be formed. As the apparatus and build plate are lowered, a metal powder layer may be added to the top surface and a laser or laser(s) used to selectively join/sinter areas to the 3D printed metal object 300 below.

During 3D printing, the laser power, re-coater blade speed, pause time between layers as well as other parameters can be adjusted to allow for the melted powder to solidify between laser passes. The first 1-10 layers can be critical as these passes form the intermetallic layer between the solid metal insert 250 and the 3D printed metal object, securing the object to the build surface.

The heat generated by laser 400 during 3D printing can increase the temperature of solid metal insert 250. One problem that this can cause is premature melting of solid metal insert 250. To prevent premature melting of solid metal insert 250 during 3D printing, this increase in temperature can be accounted for when selecting a suitable metal or metal alloy to form the insert. In some implementations, the power of laser 400 can be decreased and/or other parameters may be adjusted while forming lower layers of 3D printed metal object 300 to prevent overheating of solid metal insert 250 during 3D printing.

In some implementations, to prevent premature melting of the solid metal insert 250 during 3D printing (e.g., due to heat generated by a high powered laser 400 being absorbed by insert 250 as excess energy), the material of the build plate (i.e., build plate body 101 and gate 130) and solid metal insert 250 can be selected such that the build plate has a higher thermal conductivity than the thermal conductivity of the metal or metal alloy of the solid metal insert 250. For example, the build plate body 101 and/or build plate gate 130 can be formed of a highly thermal conductive metal or material such as aluminum, graphite, stainless steel, or copper. In this manner, the energy from the laser can be quickly transferred through the insert material to the build plate such that it doesn't saturate enough to cause melting except on the surface with the powder. In implementations where the thermal conductivity of the build plate is not higher, the thickness of the solid metal insert 250 relative to the build plate can be adapted (e.g., by making the insert thinner) such that the build plate dominates the thermal conductivity of the system as a whole.

Another problem that can occur due to laser heating of the metal, and also due to subsequent pauses between layers, is thermal expansion and contraction of the solid metal insert 250. This can cause the solid metal insert 250, which serves as the build surface, to lift from the build plate assembly 100. This lift up is undesirable as it can cause errors in the overall height (z-axis) of the 3D printed metal object 300. If the lift up is not uniform, then additional errors in the x-y plane can occur, causing the 3D printed metal object 300 to be built outside of the desired specifications.

As described herein, the build plate assembly 100 can be designed with various features to help secure the solid metal insert 250 to prevent lift-up and build failure during 3D printing. These features can provide a locking mechanism to prevent lift-up of the solid metal structure during powder bed fusion. For example, the dovetail features as descried above can prevent movement of the solid metal insert 250 in a direction perpendicular to the build surface. The use of a build plate gate 130 can help further secure the metal insert 250 in place during sintering. Other or alternative physical features other than those depicted in the figures can be used to prevent movement of the solid metal insert 250 during 3D printing. For example, the solid metal insert 250 and the interior cavity 115 of build plate body 101 can include a combination of complimentary features such as lands, grooves, and/or holes that prevent translation or other movement of the solid metal insert 250 during 3D printing (e.g., due to thermal expansion or contraction). Such features can be continuous or discrete, and can be incorporated as an alternative to or in addition to the dovetailed features depicted in some of the figures.

At the completion of 3D printing, build plate assembly 100 with 3D printed metal object 300 can be removed from 3D printing device 500. The melting temperature of the metal or metal alloy that is used to form 3D printed metal object 300 is higher than that of the solid metal insert 250. For example, the solidus temperature of the 3D printed metal object 300 can be at least 30° C. higher than the solidus temperature of the metal or metal alloy. In some implementations, the differences in melting point can be more significant. For example, in some implementations the solidus temperature of the 3D printed metal object 300 can be 50° C. higher, 100° C. higher, 200° C. higher, 400° C. higher, 600° C. higher, 800° C. higher, 1000° C. higher, or even more than 1000° C. higher than the solidus temperature of the metal or metal alloy of metal insert 250.

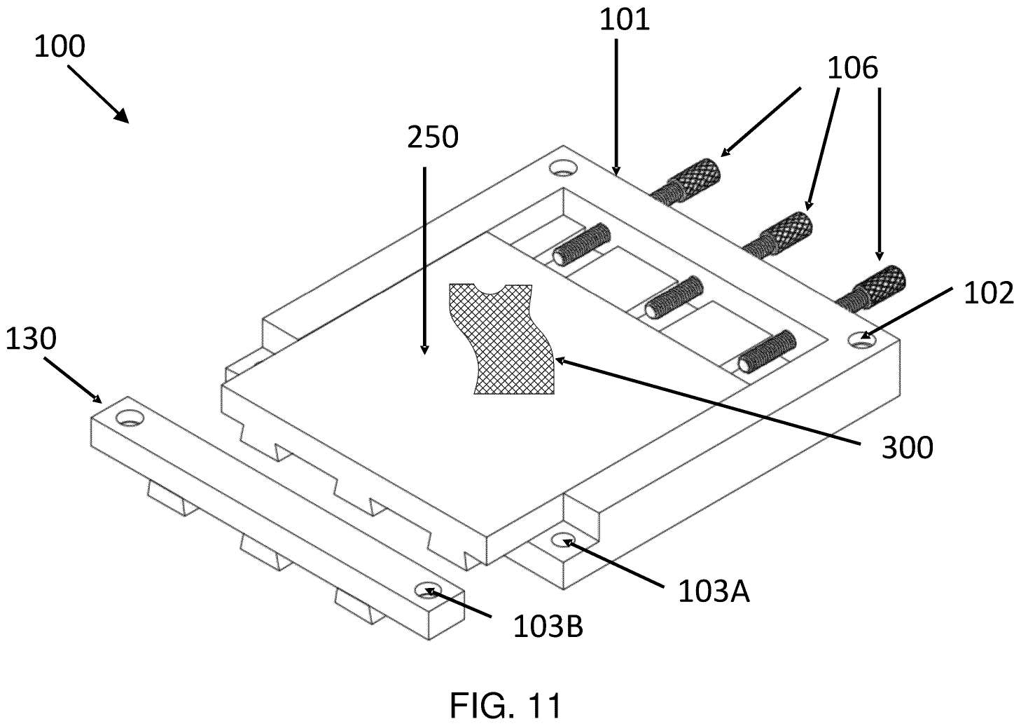

FIG. 11 shows an assembly including the 3D printed metal object 300 metallurgically joined onto a printing surface of metal insert 250 after the completion of 3D printing. To assist in removing the metal insert 250 from the interior cavity 115, post printing, one or more insert removal holes 104 can be utilized. Insert removal holes 104 are depicted in FIG. 6 and can be located on the back, interior sidewall 136 of build plate body 101, opposite the side containing the detachable build plate gate 130, and extend through the build plate body 101 and exit through the back exterior sidewall. A tool or machine (e.g., a rod, a jack screw, etc.) can apply pressure against the metal insert 250 via the one or more insert removal holes 104, causing it to slide out of build plate body 101. For example, the insert removal holes 104 can be threaded so that a jack screw 106 can be inserted into an insert removal hole 104 from an exterior side wall 133 of build plate body 101 and tightened. After the 3D print has been completed and the detachable build plate gate 130 has been removed from the build plate body 101, tightening the jack screws 106 can put pressure on the metal insert 250 and force the insert 250 along the mortise 128 and tenon 129 rails of the build plate body 101 and out through the side of the build plate body 101 once occupied by detachable build plate gate 130.

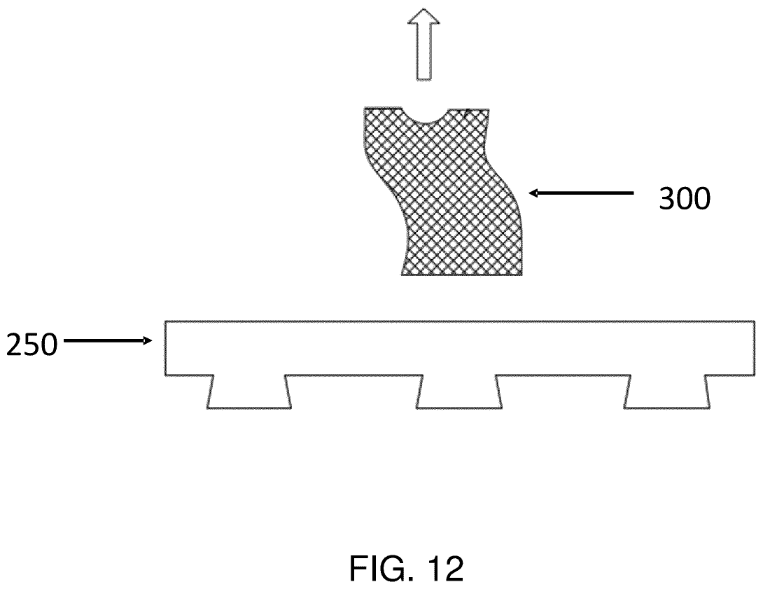

FIG. 12 depicts the metal insert 250 fully removed from the build plate body 101. Following a heat treatment to bring the metal insert 250 above its solidus point, the 3D printed metal object 300 can be easily separated from the metal insert 250. For example, the assembly, including the metal insert 250 and 3D printed metal object 300 attached thereon, can be heated (e.g., by placing the assembly in an oven) to a temperature above the solidus temperature of the lower melting temperature metal insert 250, thereby melting away the metal and releasing the 3D printed metal object 300. In other implementations, the 3D printed metal object 300 can be thermally separated from the metal insert 250 by a heat source other than an oven such as by blow torch, heated air, heated liquid, hotplate, laser, or any other suitable heat source sufficient to melt the metal insert 250, thereby releasing the 3D printed metal object 300. During the separation process, the 3D printed metal object 300 can be held in place and/or extracted by a tool. The melted metal or metal alloy can be collected in a container or collection apparatus while the 3D printed metal object 300 remains solid. The collected metal or metal alloy can be reused to reform a new insert (e.g., in mold 200) for future 3D printing operations.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

It should be appreciated that all combinations of the foregoing concepts (provided such concepts are not mutually inconsistent) are contemplated as being part of the inventive subject matter disclosed herein. In particular, all combinations of claimed subject matter appearing in this disclosure are contemplated as being part of the inventive subject matter disclosed herein.

What is claimed is:

1. A build plate assembly, comprising:
a body dimensioned for use in a 3D printing device, the body comprising an interior cavity formed through a top of the body, and extending to an opening at a first side of the body; and
a solid insert of a metal or metal alloy comprising a top surface for forming a 3D printed metal object in the 3D printing device, the solid insert configured to slidably couple, through the opening at the first side of the body, into the interior cavity of the body.

2. The build plate assembly of claim 1, further comprising: a gate configured to removably couple to the first side of the body after the solid insert slidably couples into the interior cavity, the gate configured to block the opening at the first side of the body.

3. The build plate assembly of claim 2, wherein the gate slidably couples to the first side of the body.

4. The build plate assembly of claim 3, wherein:
the interior cavity comprises a first mortise or a first tenon;
the solid insert comprises a second mortise configured to be slidably received by the first tenon, or a second tenon configured to be slidably received by the first mortise; and
the gate comprises a third mortise configured to be slidably received by the first tenon, or a third tenon configured to be slidably received by the first mortise.

5. The build plate assembly of claim 2, wherein:
the gate comprises one or more first through holes extending through the gate;
the body comprises one or more second through holes extending through the body;
after the gate is removably coupled to the first side of the body, the one or more first through holes are aligned with the one or more second through holes; and
the one or more first through holes aligned with the one or more second through holes are configured to receive one or more structural protrusions of the 3D printing device to hold the build plate assembly in place during 3D printing.

6. The build plate assembly of claim 1, wherein:
the interior cavity comprises a first mortise or a first tenon; and
the solid insert comprises a second mortise configured to be slidably received by the first tenon, or a second tenon configured to be slidably received by the first mortise.

7. The build plate assembly of claim 6, wherein the first mortise or the first tenon are angled relative to a perpendicular direction to the top surface of the solid insert, and the second mortise or the second tenon are angled relative to the perpendicular direction to prevent movement of the solid insert along the perpendicular direction after the solid insert slidably couples to the interior cavity.

8. The build plate assembly of claim 6, wherein:
the interior cavity comprises the first mortise and the first tenon; and
the solid insert comprises the second mortise configured to be slidably received by the first tenon, and the second tenon configured to be slidably received by the first mortise.

9. The build plate assembly of claim 8, wherein:
the interior cavity comprises a first plurality of mortises including the first mortise, and a first plurality of tenons including the first tenon;
the solid insert comprises a second plurality of mortises including the second mortise, and a second plurality of tenons including the second tenon;
the first plurality of mortises are configured to slidably receive the second plurality of tenons; and
the first plurality of tenons are configured to slidably receive the second plurality of mortises.

10. The build plate assembly of claim 9, wherein the first plurality of mortises, the first plurality of tenons, the second plurality of mortises, and the second plurality of tenons is each angled relative to a perpendicular direction to the top surface of the solid insert to prevent movement of the solid insert along the perpendicular direction after the solid insert slidably couples to the interior cavity.

11. The build plate assembly of claim 6, wherein:
the interior cavity comprises a first bottom surface including the first mortise or the first tenon; and
the solid insert comprises a second bottom surface, opposite the top surface, the second bottom surface comprising the second mortise or the second tenon.

12. The build plate assembly of claim 1, wherein the body comprises one or more through holes configured to receive a tool for slidably removing the solid insert from the interior cavity of the body, the one or more through holes extending through a second side of the body, opposite the first side, from an exterior of the second side to the interior cavity.

13. The build plate assembly of claim 1, wherein the metal or metal alloy has a solidus temperature that is lower than a solidus temperature of the 3D printed metal object.

14. The build plate assembly of claim 13, wherein the solidus temperature of the metal or metal alloy is between 50° C. and 250° C.

15. The build plate assembly of claim 1, wherein:
the interior cavity comprises one or more subtractive features;
the solid insert comprises one or more additive features coupled to the one or more subtractive features when the solid insert is slidably coupled in the interior cavity; and
the one or more additive features coupled to the one or more subtractive features is configured to prevent lift-up of the solid insert during 3D printing in the 3D printing device.

16. The build plate assembly of claim 1, wherein:
the interior cavity comprises one or more additive features;
the solid insert comprises one or more subtractive features coupled to the one or more additive features when the solid insert is slidably coupled in the interior cavity; and
the one or more subtractive features coupled to the one or more additive features is configured to prevent lift-up of the solid insert during 3D printing in the 3D printing device.

17. A method, comprising:
positioning a build plate assembly in a 3D printing device, the build plate assembly comprising a body with an interior cavity, and a solid insert of a metal or metal alloy slidably coupled in the interior cavity;
forming, using the 3D printing device, a 3D printed metal object onto a surface of the solid insert, the metal or metal alloy having a solidus temperature that is lower than a solidus temperature of the 3D printed metal object;
after forming the 3D printed metal object onto the surface of the solid insert, slidably removing the solid insert from the interior cavity through an opening at a first side of the body; and
after slidably removing the solid insert from the interior cavity, melting the solid insert to release the 3D printed metal object.

18. The method of claim 17, wherein:
the build plate assembly further comprises: a gate removably coupled to the first side of the body and blocking the opening at the first side of the body; and
the method further comprises: before slidably removing the solid insert from the interior cavity, removing the gate from the first side of the body.

19. The method of claim 18, further comprising before positioning the build plate assembly in the 3D printing device:
slidably inserting the solid insert in the interior cavity through the opening at the first side of the body; and
after slidably inserting the solid insert in the interior cavity, removably coupling the gate to the first side of the body.

20. The method of claim 17, wherein:
the body comprises one or more through holes extending through a second side of the body, opposite the first side, from an exterior of the second side to the interior cavity; and
slidably removing the solid insert from the interior cavity comprises: applying, using a tool inserted in the one or more through holes, force to the solid insert to slide the solid insert through the opening at the first side of the opening.

21. A mold for casting a solid metal insert for a build plate, the mold comprising:
a first side comprising a first interior casting cavity; and
a second side comprising a second interior casting cavity, the second interior casting cavity configured to face the first interior casting cavity when the mold is in a closed position,
wherein the mold is configured such that:
when the mold is in the closed position, a pour hole of the mold is configured to receive a molten metal that solidifies in the first interior casting cavity and the second interior casting cavity to form the solid metal insert, and
after the solid metal insert is formed and the mold is in an open position, the solid metal insert is slidably removable from the second interior casting cavity.

22. The mold of claim 21, wherein:
the second interior casting cavity includes a first additive feature or a first subtractive feature; and
the solid metal insert that is formed includes a second subtractive feature corresponding to the first additive feature or a second additive feature corresponding to the first subtractive feature.

23. The mold of claim 21, wherein:
the second interior casting cavity includes a first mortise or a first tenon; and
the solid metal insert that is formed includes a second tenon corresponding to the first mortise or a second mortise corresponding to the first tenon.

24. The mold of claim 21, further comprising a mold gate configured to removably couple to the second side, the mold gate configured to block an opening at the second side from which the solid metal insert is slidably removable from the second interior casting cavity.

25. The mold of claim 21, wherein:
the first side comprises a first portion of the pour hole; and
the second side comprises a second portion of the pour hole that faces the first portion of the pour hole when the mold is in the closed position.

26. The mold of claim 21, wherein:
the first side and the second side are configured to removably couple in the closed position; and
the first side and the second side are configured to be separated in the open position.
